(19) United States
(12) Patent Application Publication
(10) Pub. No.: US 2007/0161409 A1
(43) Pub. Date: Jul. 12, 2007

(54) Mobile telephone and mobile telephone network connection system

(75) Inventors: Kazuhiro Ohtsuki, Hyogo (JP); Kenji Fukuoka, Hyogo (JP); Koji Sasaki, Kyoto (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kenji Fukuoka, Kobe-shi (JP)

(21) Appl. No.: 10/589,729

(22) PCT Filed: Feb. 10, 2005
(86) PCT No.: PCT/JP05/02032

§ 371 Date: Aug. 17, 2006

(30) Foreign Application Priority Data
Feb. 17, 2004 (JP) 2004-039785
Aug. 26, 2004 (JP) 2004-246747

(51) Int. Cl. H04B 1/38

(52) U.S. Cl. 455/564; 455/551

(57) ABSTRACT

A user accesses a search server from a cellular telephone, and enters on a search page a numeric string obtained by numerical conversion of a keyword related to a desired site in accordance with an assignment relationship between characters and numerical keys. The search server searches a database by using as a key the numeric string sent thereto or a character string obtained by character conversion of the numeric string in accordance with the above-mentioned assignment relationship to retrieve candidates for a connection destination site, thereby sending back a reply to the cellular telephone of the user. The user selects a desired connection destination site from among the candidates to send back a reply to the search server. The search server responds to the cellular telephone by indicating a site address previously associated with the determined connection destination site as an access request destination. The cellular telephone accesses the connection destination site indicated by the received response.

### TECHNICAL FIELD

The present invention is an invention relating to a system for assisting in using a network on a cellular telephone.

### BACKGROUND ART

As is well known in the art, recent cellular telephones have not only a function as merely a mobile or portable telephone but also an Internet connection function. As the use of Internet-capable cellular telephones proliferates rapidly, there has been a steep increase in the number of sites designed specifically for cellular telephones such as, for example, ringing melody download sites. To access such a site from a cellular telephone, a user usually follows hierarchical levels in order on a menu screen produced to have a hierarchical structure for each cellular phone carrier, and reaches the site. To access a site not entered in any menus prepared by the cellular phone carrier, the user must directly enter the site address (URL (Uniform Resource Locator)) of the site in a browser for the cellular telephone.

However, the URL generally contains a long character string composed of alphabetical characters, numerical characters and symbols. It is very cumbersome to perform the manipulation of entering the URL from the cellular telephone including a smaller number of keys which are smaller in size and are more closely spaced than those of a personal computer. To solve the problem, Patent Document 1 proposes a system which creates a database wherein the URL of the content held by each site is associated with a relatively short code composed of about six digits, and which, when the code is entered from a cellular telephone, searches the database to acquire the URL corresponding to the code, thereby making a response indicating the URL as a site to be accessed by the cellular telephone. According to this system, the user is required only to enter a relatively short code which in turn is converted into the URL, thereby being able to access a desired site easily.

Patent Document 1: Japanese Patent Application Laid-Open No. 2001-175721

However, the user has been unable to use the system disclosed in Patent Document 1 unless the user knows the code itself assigned to the desired site. To know the code, the user has been required to browse, for example, a magazine and the like presenting homepages. Also, when the user accesses an official site entered in the menu, it has been a cumbersome process for the user to reach the desired site from a cellular telephone which is poor in operability.

### DISCLOSURE OF INVENTION

The present invention is intended for a network connection system for a cellular telephone, the network connection system causing a cellular telephone to access a site holding predetermined content via a network.

According to the present invention, there is an assignment relationship established between each numerical key included among dial keys of the cellular telephone, and a numerical character on each numerical key and/or a plurality of single alphabetical characters. The network connection system comprises: a database holding means for holding a database in which secondary data and the site address of a site are associated with each other, the secondary data being obtained by numerical conversion of primary information about the site in accordance with the assignment relationship; a search means, when receiving from the cellular telephone a search request with a numeric string entered via the dial keys and specified, for searching the database to retrieve sites associated with the secondary data including the numeric string; a search result presentation means for presenting the names of the sites retrieved by the search means as a search result to the cellular telephone; and an address specification means for acquiring from the database the site address of a site selected from the names of the presented sites via the cellular telephone to make a response indicating the site address as an access request destination of the cellular telephone.

A user can simply retrieve a desired site to easily access the desired site only by entering a relatively short numeric string obtained by the numerical conversion of a keyword related to the desired site in accordance with the assignment relationship.

According to a preferred embodiment of the present invention, when receiving from the cellular telephone a search request with a numeric string with an operator entered via the dial keys and specified, the search means searches the database in accordance with a function defined for the operator to retrieve sites associated with the secondary data including the numeric string.

The user can narrow down the search condition more finely.

According to one aspect of the present invention, in the network connection system, there is an assignment relationship established between each numerical key included among dial keys of the cellular telephone, and a numerical character on each numerical key and/or a plurality of single alphabetical characters. The network connection system comprises: an address conversion means for accepting from the cellular telephone a numeric string obtained by numerical conversion of information about a site in accordance with the assignment relationship to convert the numeric string into the site address of a site corresponding to the numeric string, thereby making a response indicating the site address as an access request destination of the cellular telephone; and a cellular telephone including a conversion request means for requesting the address conversion means to perform an address conversion with a numeric string specified, when the numeric string is directly entered on a standby screen and a predetermined dial key is pressed.

The user can easily access a desired site only by directly entering on the standby screen of the cellular telephone a relatively short numeric string obtained by the numerical conversion of a keyword related to the desired site in accordance with the assignment relationship and then pressing the predetermined dial key.

The present invention is also intended for a cellular telephone capable of connecting to a network.

It is therefore an object of the present invention to provide a cellular telephone and a network connection system for a cellular telephone which allow a user to easily access a desired site from the cellular telephone.

### BRIEF DESCRIPTION OF DRAWINGS

FIG. 1 is a diagram showing a general outline of a network connection system for a cellular telephone according to the present invention;

FIG. 2 is a diagram showing a system configuration of the network connection system of FIG. 1;

FIG. 3 is a flow chart showing a process flow for the network connection system for the cellular telephone according to the present invention;

FIG. 4 is a view showing transitions between display screens of a cellular telephone in response to the progress of processing in the present connection system;

FIG. 5 is a view illustrating a typical arrangement of dial keys of a cellular telephone;

FIG. 6 is a chart showing an assignment relationship between numerical keys and characters;

FIG. 7 is a chart showing an example of a master database;

FIG. 8 is a chart showing a database of secondary data obtained by numerical conversion of the master database of FIG. 7;

FIG. 9 is a diagram showing another example of the system configuration of the network connection system; and

FIG. 10 is a flow chart showing a process flow for the network connection system of FIG. 9.

### BEST MODE FOR CARRYING OUT THE INVENTION

A preferred embodiment according to the present invention will now be described in detail with reference to the drawings.

### 1. FIRST PREFERRED EMBODIMENT

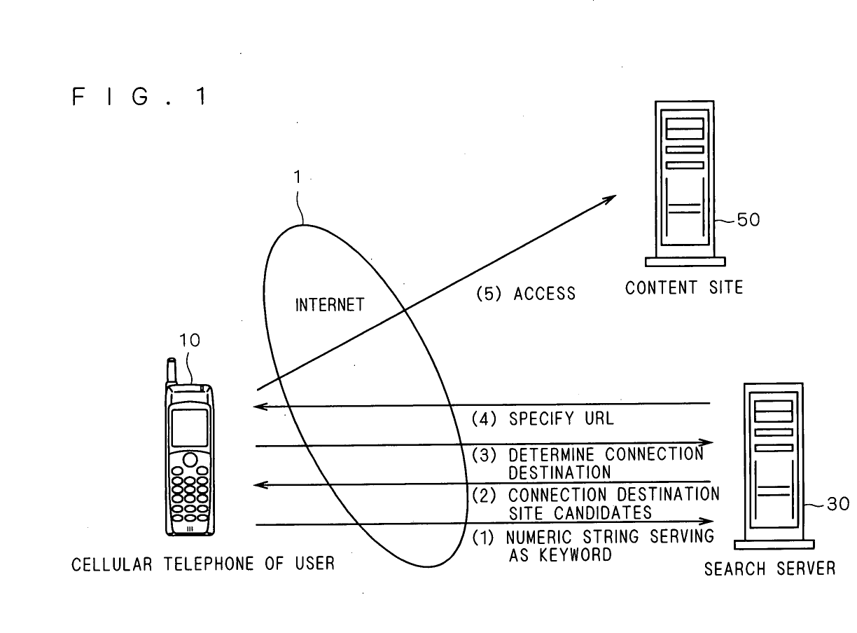

FIG. 1 is a diagram showing a general outline of a network connection system for a cellular telephone according to the present invention. A cellular telephone 10 of a user is capable of connecting to the Internet 1. A search server 30 constituting a principal part of the network connection system according to the present invention is also connected to the Internet 1. A content site 50 is located on the Internet 1. Although there are actually a multiplicity of content sites 50 holding various pieces of content on the Internet 1, only the single content site 50 is illustrated in FIG. 1 for purposes of illustration.

In the network connection system for the cellular telephone according to the present invention, the user need not necessarily know the URL of a desired site and a code assigned thereto, and additionally need not specify a desired site itself. For example, there may be cases where a user who desires to sell an automobile owned by the user wants to access any “automobile purchase information site” rather than a specific site. Such a user first accesses the search server 30 from the cellular telephone 10 to enter a numeric string on a search page, the numeric string being obtained by numerical conversion of a keyword of a desired site. The search server 30 searches a database by using the numeric string sent thereto as a key to extract candidates for a connection destination site, thereby sending back a reply to the cellular telephone 10 of the user.

The user selects a desired connection destination site from among the candidates to send back a reply to the search server 30. The search server 30 responds to the cellular telephone 10 by indicating the site address (URL) previously associated with the determined connection destination site as an access request destination. Thus, the cellular telephone 10 of the user accesses the connection destination site desired by the user.

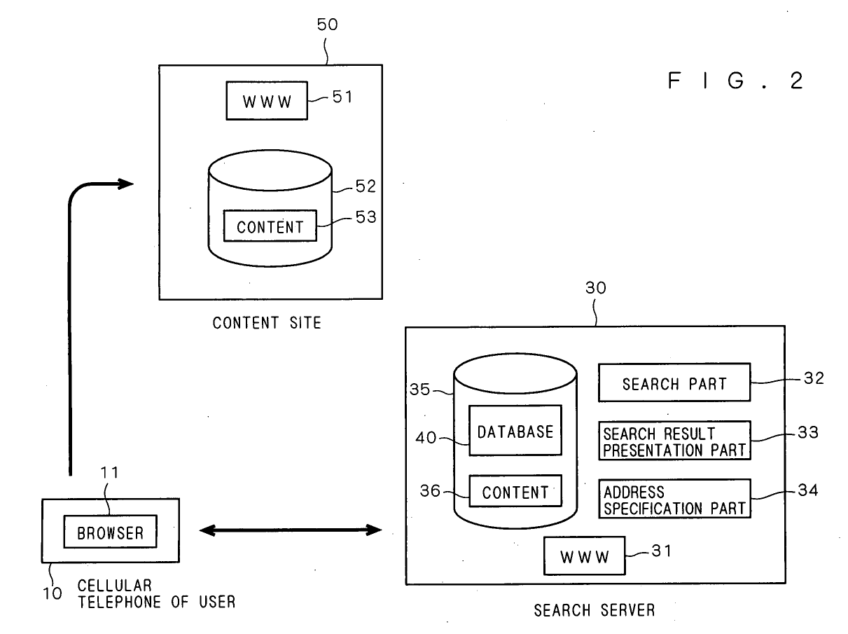

FIG. 2 is a diagram showing a system configuration of the network connection system for the cellular telephone according to the present invention. The content site 50 includes a WWW server application 51 (referred to hereinafter as a WWW 51), and makes content 53 public on the Internet 1, the content 53 being stored in a storage device 52 such as, for example, a magnetic disk and the like. The cellular telephone 10 contains a browser 11 web-accessible via the Internet 1. The cellular telephone 10 enables the user to browse the content 53 of the content site 50 by using the browser 11.

The search server 30 provides the service of conducting a search using a numeric string as a key to extract and present candidates for the connection destination site, when receiving an access request with the numeric string specified from the browser 11 of the cellular telephone 10, and the service of making a response indicating the URL of the connection destination site selected by the user from among the candidates. Specifically, the search server 30 includes a WWW server application 31 (referred to hereinafter as a WWW 31), and makes content 36 public on the Internet 1, the content 36 being stored in a storage device 35 such as, for example, a magnetic disk and the like. In other words, the search server 30 also has a function as a conventional website. The content 36 is content including a numeric string input form and a search performing object. After the user accesses the search server 30 to acquire the content 36, the user can perform a search manipulation to be described later with the numeric string specified.

The search server 30 further includes a search part 32 for searching a database 40 held in the storage device 35, a search result presentation part 33 for presenting a search result thereof to the cellular telephone 10 in the form of the candidates for the connection destination site, and an address specification part 34 for responding to the cellular telephone 10 by indicating as a link the URL of the site determined as a connection destination. These are processing parts implemented by a CPU provided in the search server 30 and executing a predetermined application. The details of the processing thereof will be described later.

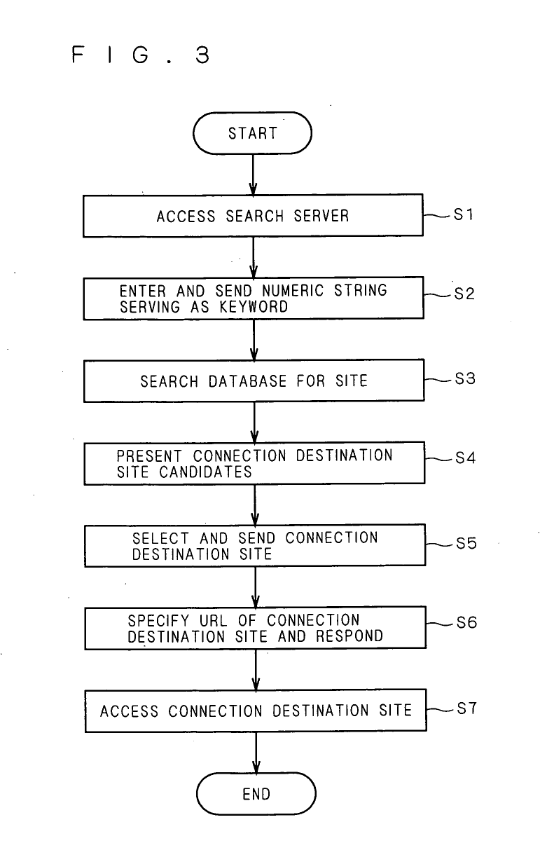

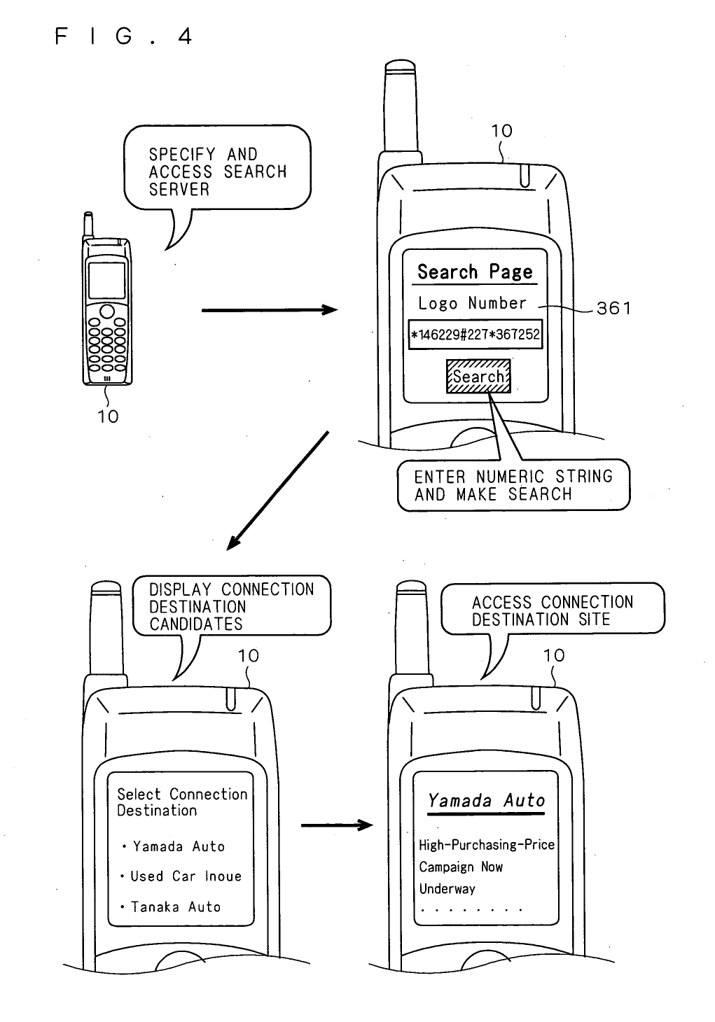

Next, a process flow for the network connection system for the cellular telephone according to the present invention will be described. FIG. 3 is a flow chart showing the process flow for the network connection system for the cellular telephone according to the present invention. FIG. 4 is a view showing transitions between display screens of the cellular telephone 10 in response to the progress of processing in the present connection system.

First, the user performs a predetermined key operation on the cellular telephone 10 to access the search server 30 (in Step S1). The predetermined key operation used herein refers to a manipulation for connection to the Internet in accordance with each cellular telephone and a manipulation for specifying the address of the search server 30. The specification of the address of the search server 30 may employ a manipulation method of directly entering the URL of the search server 30, and, if another site provides a link thereto, may employ a method of making connection to the site once and then specifying the link from the site. When making the second and subsequent accesses, the user need not perform the manipulation of specifying the address of the search server 30, for example, by saving the above-mentioned URL in the “bookmark.”

The user performs the manipulation of specifying the address of the search server 30, whereby the browser 11 contained in the cellular telephone 10 accesses the search server 30. Upon receipt of an access request from the browser 11, the search server 30 delivers the content 36 to the cellular telephone 10. When the browser 11 receives the content 36 provided thereto, a search page 361 of the search server 30 is displayed on a display screen of the cellular telephone 10 (FIG. 4).

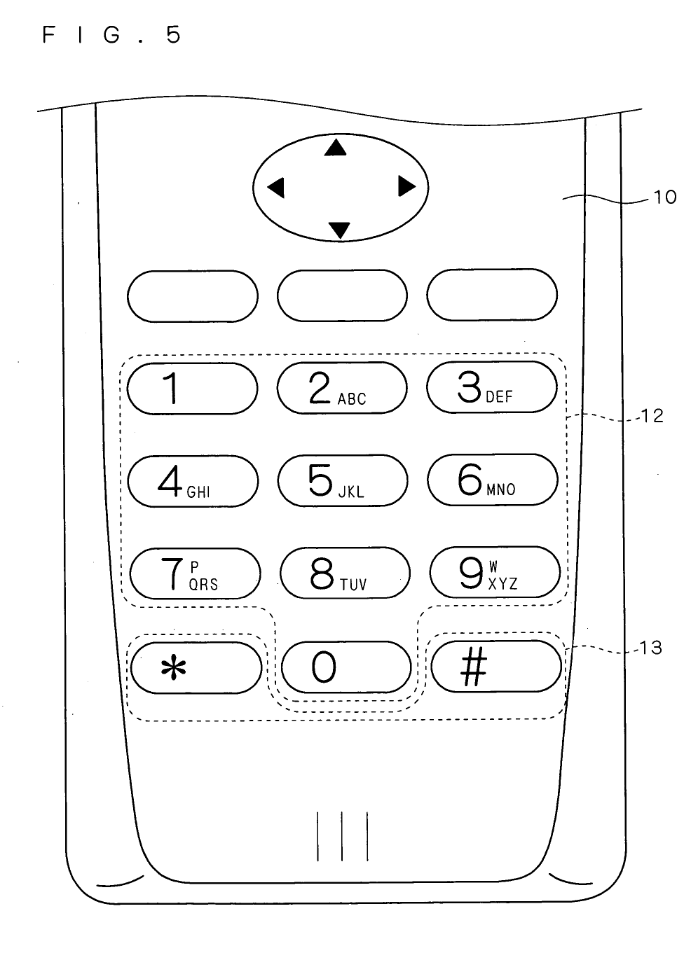

Next, the user enters and sends a numeric string on the search page 361, the numeric string being obtained by the numerical conversion of a keyword of a site which holds desired content (in Step S2). The numeric string obtained by the numerical conversion of the keyword of the site is obtained by the numerical conversion of the keyword of the site under the following rules. Dial keys for most cellular telephones include numerical keys (a so-called ten-digit keypad) and function keys (for example, a “*” key and a “#” key). FIG. 5 is a view illustrating a typical arrangement of dial keys of the cellular telephone 10. The dial keys of the cellular telephone 10 in this preferred embodiment include ten numerical keys 12 and function keys 13 including the “*” key and the “#” key. Of these keys, each of the numerical keys 12 is labeled with not only a corresponding numerical character but also alphabetical characters. This is intended to allow the entry of letters in the cellular telephone 10 on which only a limited number of keys can be arranged, as is well known. To enter the letter “K” as an example, the user usually places the cellular telephone 10 into a letter entry mode and presses the “5” key twice.

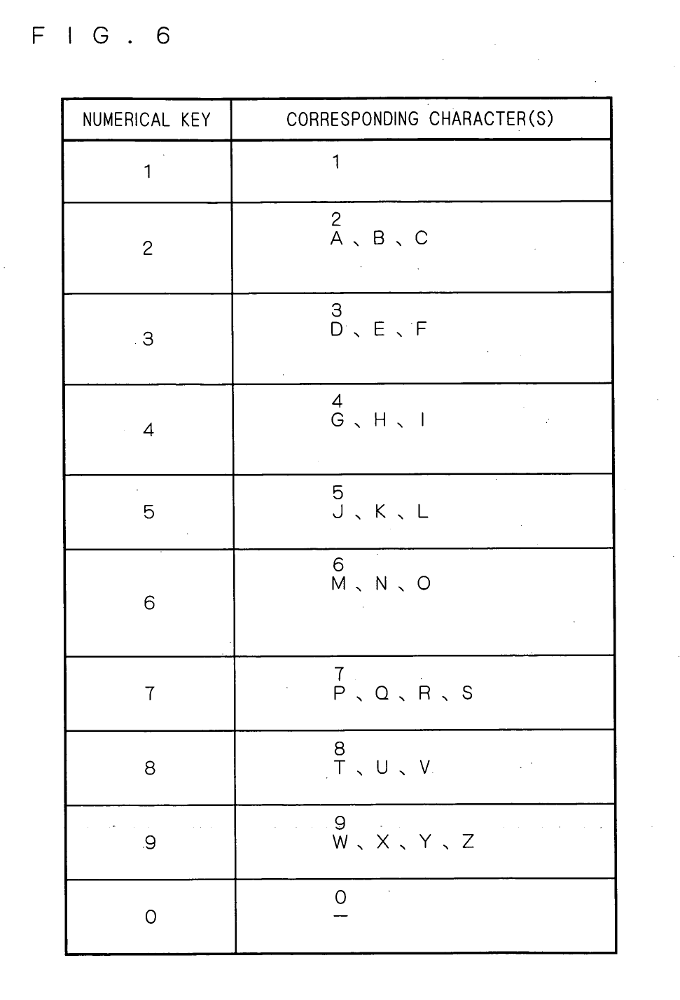

In this preferred embodiment, an assignment relationship as shown in FIG. 6 is established between each of the ten numerical keys 12, and a numerical character of a corresponding numerical key and/or a plurality of single alphabetical characters. Specifically, a numerical character and single alphabetical characters on each numerical key are assigned to each of the ten numerical keys 12. Of the numerical keys 12, the “7” key as an example is labelled with the numerical character “7” and the alphabetical characters “PQRS.” The numerical character “7” and the alphabetical characters “P, Q, R, S” are assigned to the “7” key. Of the numerical keys 12, the “1” key is labeled with only the numerical character “1.” The numerical character “1” is assigned to the “1” key. A hyphen (-) as well as the numerical character “0” is assigned to the “0” key.

The user enters a numeric string on the search page 361 by using the dial keys of the cellular telephone 10, the numeric string being obtained by the numerical conversion of a keyword of a desired site in accordance with the above-mentioned assignment relationship shown in FIG. 6. For example, a user who desires to sell an automobile owned by the user enters “227” which is obtained by the numerical conversion of the keyword “car” in accordance with the above-mentioned assignment relationship. A user who is interested in camping sites enters “2267” which is obtained by the numerical conversion of the keyword “camp.” A user who is interested in sports enters “77678” which is obtained by the numerical conversion of the keyword “sport.” The term “keyword” used herein refers to a search keyword, and a user is required only to think of and enter a suitable word related to a site which the user desires to access. In other words, the user need not previously know the URL of a desired site and a code associated therewith.

When entering a keyword on the search page 361, the user may enter a numeric string with an operator. An operator is entered by using the function keys 13 (the “*” key and the “#” key) included among the dial keys of the cellular telephone 10. Three operators “*n (where n is a numeral),” “#” and “#*” are defined in this preferred embodiment. For the entry of the operator “*n,” both of the numerical and function keys 12 and 13 are used.

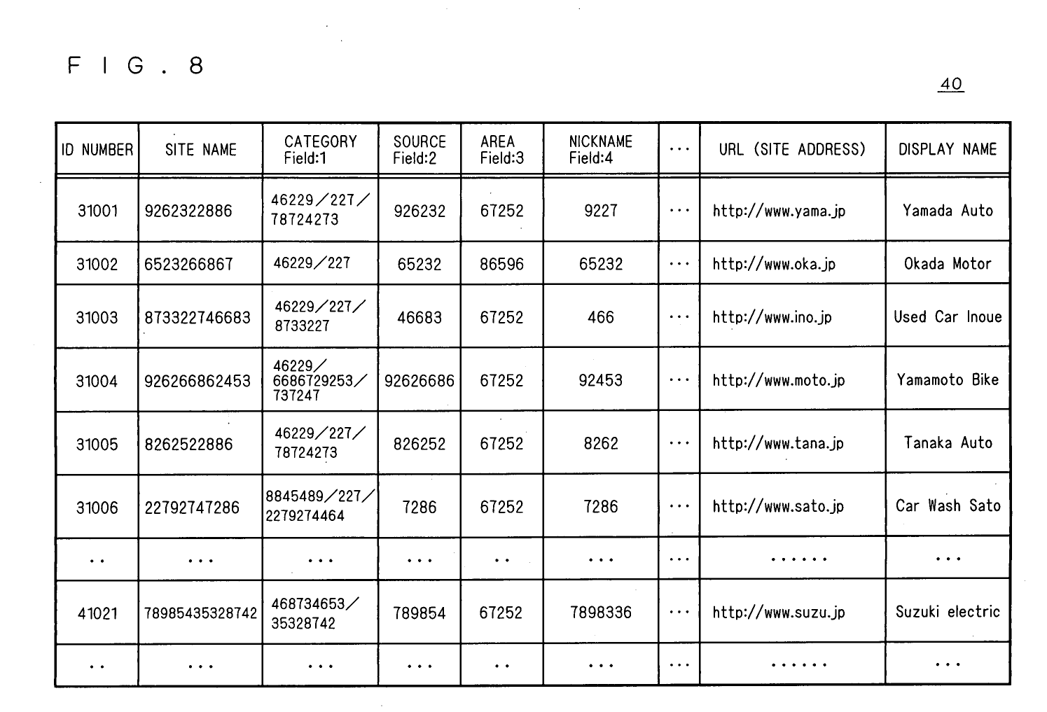

The operator “*n” is an operator for specifying a search field during the search of the database 40. Although the structure of the database 40 will be described later (with reference to FIG. 8), the database 40 are divided into fields in which information is stored. By adding the operator “*n,” the user specifies a field with a field number n as a field to be searched. If an “area” field (with the field number “3”) is set in the database 40, the user can specify the “area” field as a field to be searched by adding the operator “*3.”

The operator “#” is an operator for specifying the inclusion of all keywords as a search condition (or a so-called AND search). The operator “#*” is an operator for directly specifying an identification number associated with a site in the database 40.

The user can establish the search condition more finely by using such a numeric string with an operator. As an example, a user who desires to sell an automobile owned by the user can specify “hobby” and “car” as keywords with a category (with the field number “1”) specified as a search field, and also specify “osaka” as a keyword with the area (with the field number “3”) specified as a search field. In such a case, the user enters “*146229#227*367252” on the search page 361 by using the dial keys of the cellular telephone 10, as shown in FIG. 4. That is, the search field is narrowed to “category” by the use of the operator “*1” and the AND search is made in that field by using the keywords “hobby” and “car.” At the same time, the search field is narrowed to the area by the use of the operator “*3” and the search of that field for “Osaka” is established as the search condition.

When the user who has entered a numeric string (or a numeric string with an operator, as needed) selects a search button (See FIG. 4) displayed on the search page 361 for execution, the numeric string is sent to the search server 30. In the search server 30 having received the numeric string, the search part 32 searches the database 40 held in the storage device 35 by using the numeric string as a search key to retrieve a site associated with secondary data including the numeric string (in Step S3). The secondary data refers to data obtained by the numerical conversion of primary information which is a direct keyword about the site in accordance with the assignment relationship shown in FIG. 6. That is, the secondary data obtained by the numerical conversion of the primary information about the site in accordance with the assignment relationship of FIG. 6 is stored in the database 40 held in the storage device 35 of the search server 30.

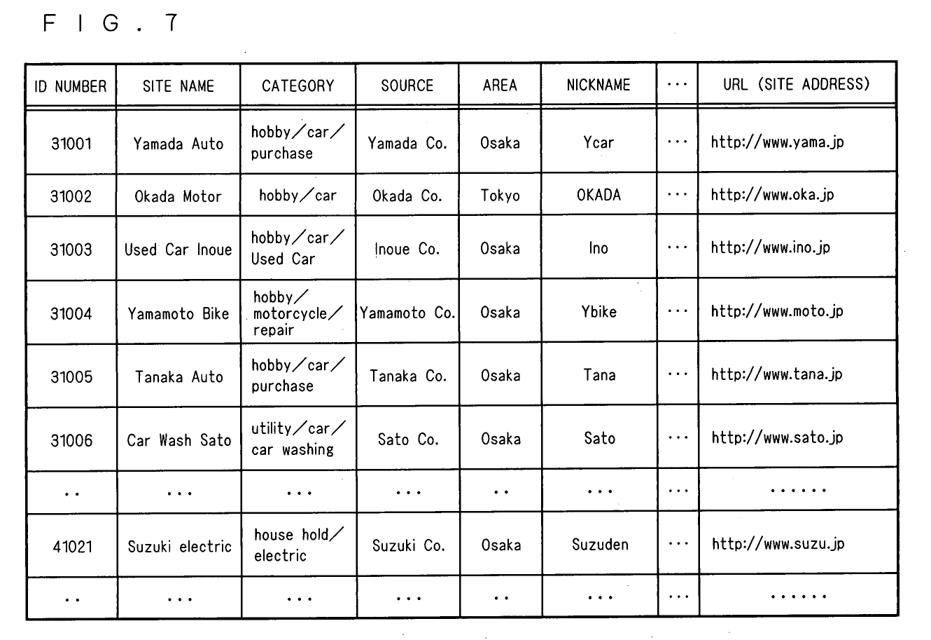

The structure of the database 40 held in the storage device 35 will be described. For the creation of the database 40, pieces of primary information serving as direct keywords related to sites are collected, and a master database is temporarily created using the pieces of primary information. FIG. 7 is a chart showing an example of the master database. An administrator of the search server 30 collects and establishes the pieces of primary information, e.g. category information, source information, area information, nickname information and the like, about various sites located on the Internet 1, and manually enters the pieces of primary information to create the master database as shown in FIG. 7. The process for creating the master database is not limited to the entry of the pieces of primary information one by one, but may be achieved by modifying an existing database or integrating existing databases together.

In the master database shown in FIG. 7, a site address is associated for each site with an identification number, a site name, a category, a source, an area, a nickname and the like. For example, the URL “http://www.ino.jp” serving as the site address is associated with the identification number “31003,” the site name “Used Car Inoue,” the category “hobby/car/used car,” the source “Inoue Co.,” the area “Osaka” and the nickname “Ino.”

The database 40 shown in FIG. 8 is obtained by carrying out the numerical conversion of the primary information stored in the master database as shown in FIG. 7 in accordance with the assignment relationship of FIG. 6 into secondary data. This database 40 is a database to be actually searched, and is stored in the storage device 35 of the search server 30. During the conversion from the primary information into the secondary data, the identification numbers are subjected to no particular numerical conversion because the primary information itself about the identification numbers is numerical data. The URLs serving as the site addresses are not subjected to the numerical conversion but are left unconverted because the URLs are necessary during the subsequent link process and are not data to be retrieved. Further, display names for display on the cellular telephone 10 as connection destination candidate sites are newly added when the database 40 is created. Because the database 40 is completed by carrying out the numerical conversion of the master database as shown in FIG. 7 in a mechanical manner in accordance with the assignment relationship of FIG. 6, the search server 30 may be provided with such a numerical conversion means so that the database 40 is automatically created only by inputting the master database as shown in FIG. 7 to the search server 30. If the database 40 is created from the master database by automatic processing, the primary information stored, for example, at the site names of the master database may be diverted intactly to the display names for the database 40.

As a result, the real data about the site address and the display name is associated for each site with the secondary data obtained by the numerical conversion of the identification number, the site name, the category, the source, the area, the nickname and the like, in the database 40 shown in FIG. 8. That is, the site address of each site is associated with the secondary data obtained by the numerical conversion of the primary information about each site in accordance with the assignment relationship of FIG. 6, in the database 40. For the site of “Used Car Inoue” as an example, the URL “http://www.ino.jp” serving as the site address and the display name “Used Car Inoue” are associated with the identification number “31003,” the site name “873322746683 (the value obtained by the numerical conversion of “Used Car Inoue”; the same shall apply hereinafter),” the category “46229/227/8733227,” the source “46683,” the area “67252” and the nickname “466.” The data in the category field is divided using “/” because each of the divisions serves as the unit of search, and the same may be applied to other fields. For example, the site name may be separated by spaces to provide “8733/227/46683.” The numeral denoted as “Field:n” in FIG. 8 designates the field number specified by the operator “*n.”

When the search part 32 receives the search request with the specified numeric string entered through the dial keys from the cellular telephone 10, the search part 32 searches the database 40 subjected to the numerical conversion as shown in FIG. 8 to retrieve a site associated with the secondary data including the numeric string. For example, when a user specifies “car” as a keyword, that is, enters and sends the numeric string “227,” the search part 32 searches all of the fields of the database 40 to retrieve sites associated with the secondary data including “227.” In the instance of FIG. 8, the sites of “Yamada Auto,” “Okada Motor,” “Used Car Inoue,” “Tanaka Auto” and “Car Wash Sato” associated with category data including “227” are retrieved. In searching the database 40 for secondary data including a predetermined numeric string, whether to count the secondary data fully matching the numeric string or the secondary data partially matching the numeric string as a hit may be previously determined as a search operation detail in the search part 32 or be made suitably changeable by settings.

When receiving the search request with the specified numeric string with an operator which is entered through the dial keys from the cellular telephone 10, the search part 32 searches the database 40 in accordance with a function defined by the operator to retrieve a site associated with the secondary data including the numeric string. For example, when a user specifies the keyword “okada” while specifying the “nickname” (with the field number “4”) as the search field, that is, enters and sends the numeric string with an operator “*465232,” the search part 32 searches the nickname field of the database 40 as the search field for the secondary data including “65232” to retrieve a site associated with the secondary data including “65232.” As a result, the site of “Okada Motor” associated with nickname data including “65232” is retrieved in the instance of FIG. 8. When a user specifies the AND search with “motorcycle” and “repair” specified as the keywords, that is, enters and sends the numeric string with an operator “6686729253#737247,” the search part 32 searches all of the fields of the database 40 to retrieve a site associated with the secondary data including both “6686729253” and “737247.” As a result, the site of “Yamamoto Bike” associated with the category data including both “6686729253” and “737247” is retrieved in the instance of FIG. 8.

In the instance shown in FIG. 4 in this preferred embodiment, the user enters the numeric string with an operator “*146229#227*367252” through the dial keys of the cellular telephone 10, and sends the numeric string with the operator to the search server 30. That is, the user specifies the execution of the AND search with “hobby” and “car” specified as the keywords while specifying the “category” (with the field number “1”) as the search field, and the execution of the search with “osaka” specified as the keyword while specifying the “area” (with the field number “3”) as the search field. In this case, the search part 32 searches the category field of the database 40 as the search field for the secondary data including both “46229” and “227,” and searches the area field as the search field for the secondary data including “67252.” The search part 32 retrieves the sites of “Yamada Auto,” “Used Car Inoue” and “Tanaka Auto” which are those counted as hits in both of the searches.

After the site retrieval using the numeric string as the search key, the processing proceeds to Step S4 in which the search result presentation part 33 of the search server 30 presents the name of each site retrieved by the search part 32 as a search result to the cellular telephone 10. The sites presented by the search result presentation part 33 are those retrieved as a result of the search for a site holding content desired by the user by using the numeric string, and are candidates for the site which the user finally desires to access. When the above-mentioned user who desires to sell the automobile owned by the user enters and sends the numeric string with the operator “*146229#227*367252,” the sites of “Yamada Auto,” “Used Car Inoue” and “Tanaka Auto” are presented as the candidates for the connection destination site by the search result presentation part 33 of the search server 30, and are displayed on the display screen of the cellular telephone 10 as shown in FIG. 4.

Subsequently, the processing proceeds to Step S5. The user who has viewed the displayed search result selects a connection destination site from among the connection destination site candidates through the cellular telephone 10 to send the selection to the search server 30. If there is no connection destination site desired by the user in the displayed search result, the processing may return to Step S2 in which the user enters a new numeric string on the search page 361. In this instance, it is assumed that the user selects the site of “Yamada Auto” on the cellular telephone 10, and sends the selection to the search server 30.

In the search server 30 having received the selection result of the user from the cellular telephone 10, the address specification part 34 acquires the site address of the selected site from the database 40 to make a response indicating the site address as the access request destination from the cellular telephone 10 (in Step S6). Specifically, the address specification part 34 acquires the site address (URL) associated with the selected site from the database 40 to cause a link from the browser 11 to change to the acquired site address. In this instance, because the site of “Yamada Auto” is selected, the address specification part 34 acquires the URL “http://www.yama.jp” of the site of “Yamada Auto” from the database 40 to cause a link from the browser 11 of the cellular telephone 10 to change to the URL “http://www.yama.jp.”

As a result, the browser 11 of the cellular telephone 10 accesses the content site 50 of “Yamada Auto” (in Step S7). Then, a page included in the content of “Yamada Auto” is displayed on the display screen of the cellular telephone 10, as shown in FIG. 4.

In the above-mentioned manner, even if a user does not know the URL of a site desired to access, the user can retrieve the connection destination site candidates only by entering a numeric string (or a numeric string with an operator, as needed) obtained by the numerical conversion of a keyword related to the site in accordance with the assignment relationship of FIG. 6, and can access the desired site easily by selecting the connection destination site from among the candidates.

In particular, the database 40 to be searched stores therein the secondary data obtained by the numerical conversion of the primary information serving as direct keywords related to sites in accordance with the assignment relationship of FIG. 6, that is, the numerical data obtained by converting numerical or alphabetical characters denoting the primary information into an equal number of numerical characters. Therefore, the user can easily retrieve and access a desired site only by entering numerical characters composed of a smaller number of digits as compared with directly entering the numerical or alphabetical characters denoting the keyword.

Conventionally, it has been very cumbersome to enter a URL from a cellular telephone which is poor in operability. Additionally, even when the user accesses an official site entered in the menu or uses a search site, the poor operability has been a significant factor hindering the usage of the Internet from cellular telephones. However, in a manner as described in this preferred embodiment, the user can enter a numeric string readily as if the user entered a telephone number to easily retrieve and access a desired site. This in turn promotes the usage of the Internet from cellular telephones. The assignment relationship as shown in FIG. 6 conforms to the alphabetical characters on the numerical keys of typical cellular telephones, so that the user can enter a numeric string obtained by the numerical conversion of a keyword without feeling much uncomfortable. The assignment relationship as shown in FIG. 6 rather improves operability because the number of times the user presses the keys is much smaller than that for ordinary character entry.

### 2. SECOND PREFERRED EMBODIMENT

Next, a second preferred embodiment according to the present invention will be described. In the first preferred embodiment, the database 40 containing the secondary data obtained by the numerical conversion of the primary information in accordance with the assignment relationship of FIG. 6 is previously created and stored in the storage device 35 of the search server 30, and the candidates for the connection destination site are extracted by searching the database 40 by using the numeric string entered from the cellular telephone 10 as a direct key. The second preferred embodiment is adapted to extract the connection destination site candidates by searching a database containing the primary information by using as a key a character string inferred from a numeric string entered from the cellular telephone 10.

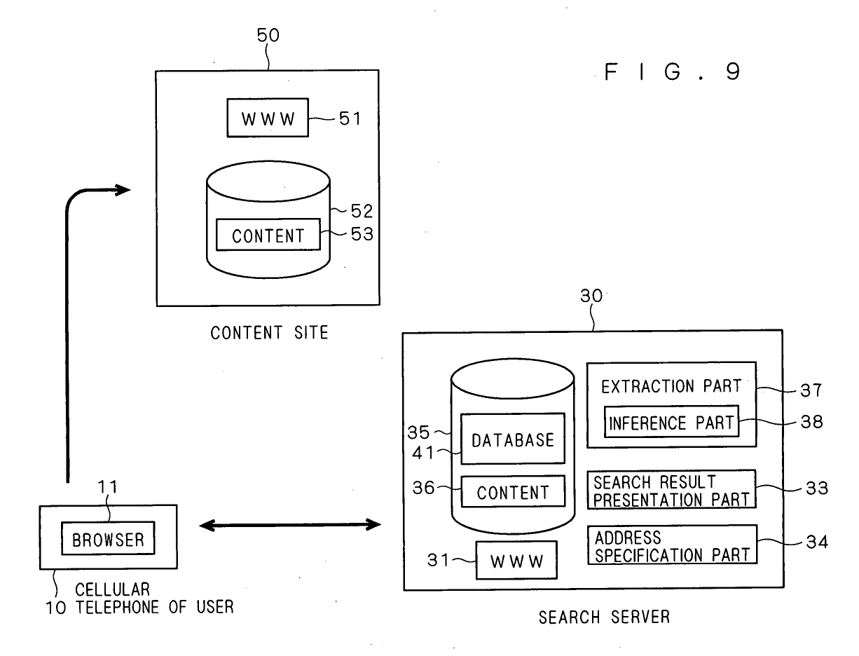

FIG. 9 is a diagram showing a system configuration of the network connection system according to the second preferred embodiment. Components in FIG. 9 similar to those in the first preferred embodiment (FIG. 2) are designated by the same reference numerals and characters. The constructions of the content site 50 and the cellular telephone 10 are identical with those of the first preferred embodiment, and will not be described.

The search server 30 according to the second preferred embodiment provides the service of conducting a search using as a key a character string obtained by character conversion of a numeric string in accordance with the assignment relationship of FIG. 6 to extract and present candidates for the connection destination site, when receiving an access request with the numeric string specified from the browser 11 of the cellular telephone 10, and the service of making a response indicating the URL of the connection destination site selected by a user from among the candidates. Specifically, the search server 30 includes the WWW 31, and makes the content 36 public on the Internet 1, the content 36 being stored in the storage device 35 such as, for example, a magnetic disk and the like. The content 36 is content including a numeric string input form and a search performing object. After the user accesses the search server 30 to acquire the content 36, the user can perform a search manipulation to be described later with the numeric string specified.

The search server 30 according to the second preferred embodiment further includes an extraction part 37 for extracting site candidates corresponding to the numeric string accepted from the cellular telephone 10, the search result presentation part 33 for presenting the names of the extracted site candidates as a search result to the cellular telephone 10, and the address specification part 34 for responding to the cellular telephone 10 by indicating as a link the URL of the site determined as a connection destination. The extraction part 37 includes an inference part 38 for converting the numeric string accepted from the cellular telephone 10 into characters in accordance with the assignment relationship of FIG. 6. These are processing parts implemented by the CPU provided in the search server 30 and executing a predetermined application. The search result presentation part 33 and the address specification part 34 have functions similar to those of the first preferred embodiment.

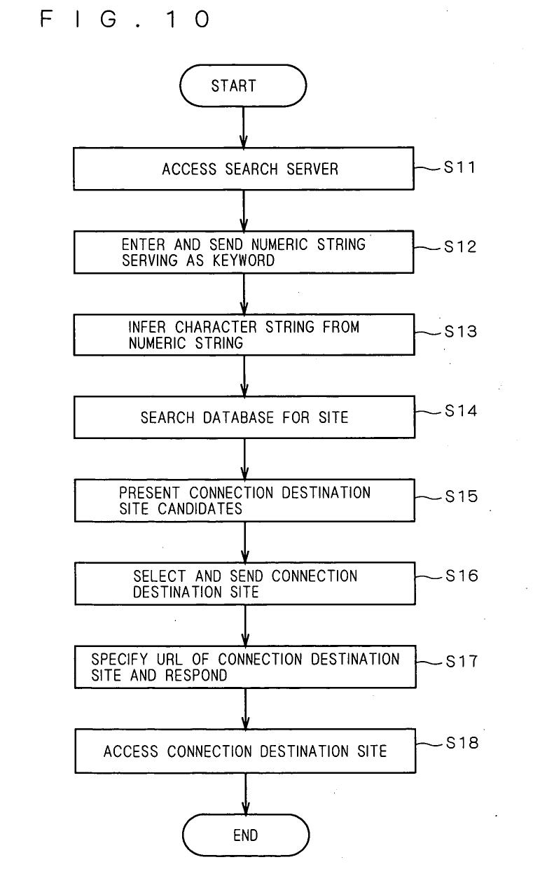

FIG. 10 is a flow chart showing a process flow for the network connection system according to the second preferred embodiment. The user performs a predetermined key operation on the cellular telephone 10 to access the search server 30 (in Step S11). The predetermined key operation used herein refers to the manipulation for connection to the Internet in accordance with each cellular telephone and the manipulation for specifying the address of the search server 30.

The user performs the manipulation of specifying the address of the search server 30, whereby the browser 11 contained in the cellular telephone 10 accesses the search server 30. Upon receipt of an access request from the browser 11, the search server 30 delivers the content 36 to the cellular telephone 10. When the browser 11 receives the content 36 provided thereto, the search page 361 of the search server 30 is displayed on the display screen of the cellular telephone 10 (See FIG. 4).

Next, the user enters and sends a numeric string on the search page 361, the numeric string being obtained by the numerical conversion of information about (or a keyword of) a site which holds desired content (in Step S12). The numeric string obtained by the numerical conversion of the keyword of the site is a numeric string obtained by the numerical conversion of the keyword in accordance with the assignment relationship of FIG. 6. The manner of entry as viewed from the standpoint of the user is identical with that of the first preferred embodiment.

When the user who has entered the numeric string obtained by the numerical conversion of the information about the site in accordance with the assignment relationship of FIG. 6 selects the search button displayed on the search page 361 for execution, the numeric string is sent to the search server 30. In the search server 30 having received the numeric string, the inference part 38 infers a character string from the numeric string (in Step S13). The inference part 38 contains an inference engine for converting a numeric string into a character string in accordance with the assignment relationship of FIG. 6, and a dictionary for extraction of words which are candidates for conversion.

It is apparent from FIG. 6 that a plurality of characters are assigned to a single numeric. Thus, the conversion from a character string (which may contain a numerical character) to a numeric string in accordance with the assignment relationship of FIG. 6 is a unique conversion, but there can be a plurality of candidates when a conversion is made from a numeric string to a character string (which may contain a numerical character). As an example, when the character string “car” is converted to a numeric string in accordance with the assignment relationship of FIG. 6, the conversion to “227” is uniquely made. However, when the numeric string “227” is converted to a character string in accordance with the assignment relationship, there can be a plurality of candidates such as “car,” “bar,” “cap” and the like. Such candidates for conversion are previously stored in the dictionary of the inference part 38. In the search server 30 having received the numeric string entered from the cellular telephone 10, the inference part 38 makes an inference by converting the numeric string into characters in accordance with the assignment relationship of FIG. 6 and then extracting a character string stored in the dictionary from among the characters. At this time, there is a possibility that a plurality of character strings are extracted. In general, the smaller the number of characters included in the numeric string, the higher the possibility that the number of character string candidates increases.

Subsequently, the extraction part 37 searches a database 41 held in the storage device 35 by using the above-mentioned inferred character string as a search key to retrieve a site associated with the information containing the character string (in Step S14). The database 41 according to the second preferred embodiment is constructed by conventional character information (which may include numeric information), and is similar to the master database of the first preferred embodiment (See FIG. 7). The database 41, which is an general database, need not always be held in the storage device 35 of the search server 30. An existing database accessible through the Internet 1 may be diverted to the database 41.

When the user specifies “car” as the keyword, that is, enters and sends the numeric string “227,” the inference part 38 infers the character string “car” from the numeric string “227,” and the extraction part 37 searches the database 41 to retrieve a site associated with the information including “car.” At this time, whether to count the information fully matching the character string or the information partially matching the character string as a hit may be previously determined as a search operation detail in the search part 32 or be made suitably changeable by settings.

The subsequent processing is nearly identical with that of the first preferred embodiment. After the site retrieval using the character string as the search key, the processing proceeds to Step S15 in which the search result presentation part 33 of the search server 30 presents the name of each site retrieved by the extraction part 37 as a search result to the cellular telephone 10. The sites presented by the search result presentation part 33 are the retrieved sites holding content desired by the user, and include candidates for the site which the user finally desires to access.

Subsequently, the processing proceeds to Step S16. The use who has viewed the displayed search result selects a connection destination site from among the connection destination site candidates through the cellular telephone 10 to send the selection to the search server 30. In the search server 30 having received the selection result of the user from the cellular telephone 10, the address specification part 34 acquires the site address of the selected site from the database 41 to make a response indicating the site address as the access request destination from the cellular telephone 10 (in Step S17). Specifically, the address specification part 34 acquires the site address (URL) associated with the selected site from the database 41 to cause a link from the browser 11 to change to the acquired site address. As a result, the browser 11 of the cellular telephone 10 accesses the site address specified by the address specification part 34 (in Step S18).

In the above-mentioned manner, even if a user does not know the URL of a site desired to access, the user can retrieve the connection destination site candidates only by entering a numeric string (or a numeric string with an operator, as needed) obtained by the numerical conversion of a keyword related to the site in accordance with the assignment relationship of FIG. 6, and can access the desired site easily by selecting the connection destination site from among the candidates, as in the first preferred embodiment. In particular, the user can easily retrieve and access a desired site only by entering a numeric composed of a relatively small number of digits equal in number to the characters of the direct keyword related to the site.

Further, the user can enter a numeric string readily as if the user entered a telephone number to easily retrieve and access a desired site. This in turn promotes the usage of the Internet from cellular telephones.

In particular, the second preferred embodiment is adapted to search the database storing the primary information therein by using a character string inferred from a numeric string entered from the cellular telephone 10 as a key to extract the connection destination site candidates. This allows the intact use of an existing database, to achieve the search from abundant information.

### 3. MODIFICATIONS

Although the preferred embodiments according to the present invention have been described hereinabove, the present invention is not limited to the above-mentioned embodiments. For example, the user enters a numeric string obtained by the numerical conversion of a keyword related to a site desired by the user in the above-mentioned preferred embodiments. However, if the identification number of a site stored in the databases 40 and 41 is known, the identification number may be entered directly from the cellular telephone 10. In this case, a numeric string with an operator such that the operator “#*” is added shall be used to indicate that the numeric string denotes the identification number. For example, when the user wants to access the site of “Suzuki electric” in the above-mentioned instance, the user enters “#*41021” on the search page 361 to send the same. In this case, the search part 32 searches the database 40 for “41021” by using the identification number as a search field to specify the site of “Suzuki electric” corresponding thereto. Subsequently, the search result presentation part 33 presents “Suzuki electric” as a search result. If the user approves of this, the address specification part 34 responds to the cellular telephone 10 by indicating the site address of “Suzuki electric” as a link.

The assignment relationship between the numerical keys and the characters is not necessarily limited to the corresponding relationship shown in FIG. 6, but may be arbitrarily established. In consideration for the convenience for the user, it is preferred to adopt the assignment relationship of FIG. 6 conforming to the alphabetical characters on the numerical keys of typical cellular telephones.

The database 40 to be searched is not limited to that shown in FIG. 8, but various fields may be set if only site addresses are associated with the secondary data obtained by the numerical conversion of the primary information belonging to each field in accordance with the assignment relationship.

The definitions of the operators are not limited to the example of the above-mentioned preferred embodiments, but various definitions may be given to combinations of function keys and numerical keys. For example, the function of specifying which is to be retrieved, the secondary data fully matching the numeric string obtained by the numerical conversion of a keyword, the secondary data partially matching the numeric string, or the secondary data prefix-matching the numeric string, when the databases 40 and 41 are searched may be defined for a suitable combination of the function keys and the numerical keys. When the secondary data including the numeric string obtained by the numerical conversion of the keyword is expected to be not so large in number, the specification of the prefix matching using an operator allows the extraction of a wider range of candidate sites. In contrast to this, when there is expected to be a large amount of secondary data, the specification of the full matching using an operator allows the candidate sites to be narrowed to more suitable ones.

The numerical keys themselves to be inputted as the operators may be those conforming to the assignment relationship of FIG. 6. For example, the “nickname” field is specified as a search field by entering the operator “*4” in the above-mentioned preferred embodiments. Instead, this may be changed to the entry of “*64256263.” The user can make an entry with an operator without the need to remember the definitions of the operators one by one.

In the above-mentioned preferred embodiments, the search result presentation part 33 presents the names of the extracted sites as a search result to the cellular telephone 10 independently of the number of sites extracted by the search made by the search part 32. However, the search result presentation part 33 may present a character string obtained by the character conversion of the entered numeric string in accordance with the assignment relationship of FIG. 6, and the number of names of the sites containing the character string to the cellular telephone 10 if the number of extracted sites exceeds a predetermined number. As will be apparent from FIG. 6, the conversion from a character string to a numeric string is uniquely determined, but the inverse of the conversion is not uniquely determined. Thus, when only the numeric string “227” as an example is entered and sent, the sites related to “bar” and the like are also extracted in addition to the sites related to “car,” so that a considerable number of hits are found. In such a case, the search result presentation part 33 is presented to the cellular telephone 10 in a manner such as “car: xx hits” and “bar: yy hits” and is displayed on the display screen of the cellular telephone 10. The user who has viewed this enters and sends a numeric string obtained by the numerical conversion of a new keyword in accordance with the assignment relationship shown in FIG. 6 to refine the search. Because the billing for information communication via cellular telephones is often on a per-packet basis, the economic burden on users can be alleviated by reducing the number of packets sent and received.

In the above-mentioned second preferred embodiment, the character string candidates inferred by the inference part 38 may be sent once to the cellular telephone 10, and the user who has viewed the candidates may select a suitable keyword from among the candidates. Then, the extraction part 37 may search the database 41 using the keyword as the search key. In this manner, the sites extracted by the extraction part 37 are narrowed to only a site desired by the user.

Additionally, in the above-mentioned preferred embodiments, the user enters the numeric string after accessing the search server 30 by the predetermined key operation through the cellular telephone 10. Instead of this, the browser 11 may be adapted to request the search part 32 to conduct a search with a numeric string specified, when the user directly enters the numeric string on a standby screen and presses a predetermined dial key. That is, when the user directly enters the numeric string on the standby screen and presses the predetermined dial key, the browser 11 recognizes the pressing of the dial key as a search command with the numeric string specified, and directly requests the search server 30 to make the search. In the search server 30 having received the search request with the numeric string specified, the search part 32 searches the database 40 by using the numeric string as the search key (or searches the database 41 by using the character string inferred by the inference part 38 as the search key), as in the above-mentioned preferred embodiments. In this manner, the user need not take the trouble to perform the manipulation of accessing the search server 30, but can easily make a search for a desired site to access the desired site only by directly entering a numeric string obtained by the numerical conversion of a keyword related to the desired site on the standby screen of the cellular telephone 10 and pressing a predetermined dial key. This significantly encourages the willingness of the user to access sites via the cellular telephone 10.

1. A network connection system for a cellular telephone, the network connection system causing a cellular telephone to access a site holding predetermined content via a network,
there being an assignment relationship established between each numerical key included among dial keys of the cellular telephone, and a numerical character on each numerical key and/or a plurality of single alphabetical characters,
said network connection system comprising:
a database holding means for holding a database in which secondary data and the site address of a site are associated with each other, the secondary data being obtained by numerical conversion of primary information about said site in accordance with said assignment relationship;
a search means, when receiving from the cellular telephone a search request with a numeric string entered via said dial keys and specified, for searching said database to retrieve sites associated with the secondary data including said numeric string;
a search result presentation means for presenting the names of the sites retrieved by said search means as a search result to said cellular telephone; and
an address specification means for acquiring from said database the site address of a site selected from the names of the presented sites via said cellular telephone to make a response indicating the site address as an access request destination of said cellular telephone.

2. The network connection system according to claim 1, wherein
when receiving from said cellular telephone a search request with a numeric string with an operator entered via said dial keys and specified, said search means searches said database in accordance with a function defined for the operator to retrieve sites associated with the secondary data including the numeric string.

3. The network connection system according to claim 2, wherein
the function defined for said operator includes the function of specifying a search field of said database.

4. The network connection system according to claim 3, wherein
the function defined for said operator includes the function of specifying which is to be retrieved, secondary data fully matching said numeric string, secondary data partially matching said numeric string, or secondary data prefix-matching said numeric string.

5. The network connection system according to claim 2, wherein
said operator is entered via a function key included among the dial keys of the cellular telephone.

6. The network connection system according to claim 1, wherein
the search result presentation means presents a character string obtained by character conversion of said numeric string in accordance with said assignment relationship and the number of names of sites including the character string to said cellular telephone when the number of sites retrieved by said search means exceeds a predetermined number.

7. The network connection system according to claim 1, wherein
said cellular telephone includes
a search request means for requesting said search means to make a search with a numeric string specified, when the numeric string is entered on a standby screen and a predetermined dial key is pressed.

8. A network connection system for a cellular telephone, the network connection system causing a cellular telephone to access a site holding predetermined content via a network,
there being an assignment relationship established between each numerical key included among dial keys of the cellular telephone, and a numerical character on each numerical key and/or a plurality of single alphabetical characters,
said network connection system comprising:
an extraction means for accepting from the cellular telephone a numeric string obtained by numerical conversion of information about a site in accordance with said assignment relationship to extract site candidates corresponding to the numeric string;
a search result presentation means for presenting the names of the site candidates extracted by said extraction means as a search result to said cellular telephone; and
an address specification means for acquiring the site address of a site selected from the names of the presented site candidates via said cellular telephone to make a response indicating the site address as an access request destination of said cellular telephone.

9. The network connection system according to claim 8, further comprising
a database holding means for holding a database in which information about a site and the site address of said site are associated with each other,
wherein said extraction means searches said database to retrieve a site associated with information including a character string obtained by character conversion of the numeric string accepted from the cellular telephone in accordance with said assignment relationship, and
wherein said address specification means acquires the site address of the site selected via said cellular telephone from said database.

10. A network connection system for a cellular telephone, the network connection system causing a cellular telephone to access a site holding predetermined content via a network,
there being an assignment relationship established between each numerical key included among dial keys of the cellular telephone, and a numerical character on each numerical key and/or a plurality of single alphabetical characters,
said network connection system comprising:
an address conversion means for accepting from the cellular telephone a numeric string obtained by numerical conversion of information about a site in accordance with said assignment relationship to convert the numeric string into the site address of a site corresponding to the numeric string, thereby making a response indicating the site address as an access request destination of said cellular telephone; and
a cellular telephone including a conversion request means for requesting said address conversion means to perform an address conversion with a numeric string specified, when the numeric string is directly entered on a standby screen and a predetermined dial key is pressed.

11. A cellular telephone capable of connecting to a network,
there being an assignment relationship established between each numerical key included among dial keys of the cellular telephone, and a numerical character on each numerical key and/or a plurality of single alphabetical characters,
said cellular telephone comprising
an address request means for making a request while specifying the site address of a site corresponding to a numeric string as a connection destination, when the numeric string is directly entered on a standby screen and a predetermined dial key is pressed, the numeric string being obtained by numerical conversion of information about a site in accordance with said assignment relationship.
